(19) United States
(12) Patent Application Publication
(10) Pub. No.: US 2025/0189467 A1
(43) Pub. Date: Jun. 12, 2025

(54) SYSTEMS AND METHODS FOR MOBILE ELEMENTAL ANALYSIS

(71) Applicant: IXRF, Inc., Austin, TX (US)

(72) Inventors: Robert Clayton Tisdale, Austin, TX (US); Andrew Ma, Austin, TX (US); David Burger, Leander, TX (US)

(73) Assignee: IXRF, Inc., Austin, TX (US)

(21) Appl. No.: 18/968,620

(22) Filed: Dec. 4, 2024

Related U.S. Application Data
(60) Provisional application No. 63/607,503, filed on Dec. 7, 2023.

(51) Int. Cl. G01N 23/223

(52) U.S. Cl. CPC G01N 23/223; G01N 2223/301; G01N 2223/303

(57) ABSTRACT

In some embodiments, an X-ray fluorescence (XRF) analysis system may include a stand having at least one stage and a movement feature. The movement feature may be configured to facilitate a movement of the stand. The system may include a spectrometer coupled to one of the at least one stage. The spectrometer may be configured to move in one or more axes to analyze a sample. The system may include a computing device communicatively coupled to the stand and the spectrometer. The computing device may have a processor with instructions to: determine a plurality of defined positions of the sample, activate an X-ray source of the spectrometer, calibrate one or more of the at least one stage, map the sample with the spectrometer, and display an elemental map of the sample on a display.

### CROSS-REFERENCE TO RELATED APPLICATIONS

This application claims the benefit of priority under 35 U.S.C. § 119 (e) to prior U.S. Provisional Patent Application No. 63/607,503 filed on Dec. 7, 2023, the disclosure of which is incorporated by reference herein in its entirety.

### FIELD OF DISCLOSURE

The disclosed systems and methods relate to the field of elemental analysis. More particularly, the disclosed systems and methods may be applied to in situ elemental analysis by X-ray fluorescence (XRF) spectrometry elemental analysis, imaging, and mapping spectrometric measurements of both smooth and irregular surfaces.

### BACKGROUND

X-ray fluorescence spectrometric measurement is used in materials analysis. XRF is a technique for determining the elemental composition and other properties, such as thickness, of a sample. XRF analyzers include an X-ray source, which irradiates the sample with sufficient energy to excite X-ray fluorescence from the elements of interest within the sample. XRF analyzers also include an X-ray detector for detecting X-ray scatter from the sample and the characteristic X-ray fluorescence emitted by the sample in response to the irradiation. Each element in the sample emits X-ray fluorescence at discrete energies that are characteristic of the elements present. The detected X-ray fluorescence is analyzed to find the energies or the wavelengths of the detected photons, and the number of emitted photons (i.e., intensity) as a function of energy or wavelength. The detected X-ray fluorescence can also determine the qualitative composition, quantitative composition, thickness, and other properties of the sample. Conventional XRF systems are typically not optimized for in situ elemental analysis of large samples.

### SUMMARY

In some embodiments, an X-ray fluorescence (XRF) analysis system may include a stand having at least one stage and a movement feature. The movement feature may be configured to facilitate a movement of the stand. The system may include a spectrometer coupled to one of the at least one stage. The spectrometer may be configured to move in one or more axes to analyze a sample. The system may include a computing device communicatively coupled to the stand and the spectrometer. The computing device may have a processor with instructions to: determine a plurality of defined positions of the sample, activate an X-ray source of the spectrometer, calibrate one or more of the at least one stage, map the sample with the spectrometer, and display an elemental map of the sample on a display.

In some embodiments, the at least one stage may include at least one X-stage, a Y-stage, and a Z-stage. In some embodiments, the spectrometer may be coupled to the Z-stage. In some embodiments, the Z-stage may be configured to rotate around a plane defined by the Z-stage. In some embodiments, the at least one X-stage may include a first X-stage and a second X-stage. In some embodiments, the spectrometer may have one or more position sensors used to determine the plurality of defined positions on the sample. In some embodiments, the system may include a safety system communicatively coupled to the computing device. In some embodiments, the safety system may include one or more safety sensors configured to secure the X-ray source when the one or more safety sensors detect an encroachment. In some embodiments, the safety system may include one or more safety markers configured to project an exclusion zone at a distance from the spectrometer. In some embodiments, the movement feature may be a caster assembly.

In some embodiments, a method of X-ray fluorescence analysis may include determining a plurality of defined positions on a sample. The method may include activating an X-ray source of a spectrometer. The method may include calibrating one or more of at least one stage. The method may include mapping the sample with the spectrometer. In some embodiments, the method may include displaying an elemental map of the sample on a display.

In some embodiments, the method may include moving a position of the spectrometer such that the spectrometer is adjacent to the sample. In some embodiments, the method may include adjusting the spectrometer by moving one or more of the at least one stage. In some embodiments, the method may include in response to one or more safety sensors detecting an encroachment, securing the X-ray source. In some embodiments, in response to activating the X-ray source, projecting an exclusion zone at a distance from the spectrometer.

In some embodiments, a non-transitory computer readable medium may have instructions stored thereon. The instructions, when executed by at least one processor, may cause a computing device to perform operations. The operations may include determining a plurality of defined positions of a sample. The operations may include activating an X-ray source of a spectrometer. The operations may include calibrating one or more of at least one stage. The operations may include mapping the sample with the spectrometer. The operations may include displaying an elemental map of the sample on a display.

In some embodiments, the operations may include moving a position of the spectrometer such that the spectrometer is adjacent to the sample. In some embodiments, the operations may include adjusting the spectrometer by moving one or more of the at least one stage. In some embodiments, the operations may include in response to one or more safety sensors detecting an encroachment, securing the X-ray source. In some embodiments, the operations may include in response to activating the X-ray source, projecting an exclusion zone at a distance from the spectrometer.

### BRIEF DESCRIPTION OF THE DRAWINGS

The features and advantages of the present disclosure will be more fully disclosed in, or rendered obvious by, the following detailed descriptions of example embodiments. The detailed descriptions of the example embodiments are to be considered together with the accompanying drawings, wherein like numbers refer to like parts and further wherein:

FIG. 1A illustrates an exemplary mobile XRF mapping spectrometer system in accordance with some embodiments;

FIG. 1B illustrates another exemplary mobile XRF mapping spectrometer system in accordance with some embodiments;

FIG. 2 illustrates aspects of an exemplary XRF spectrometer in accordance with some embodiments;

FIG. 3 illustrates a functional block diagram of an exemplary mobile XRF mapping spectrometer system in accordance with some embodiments;

FIG. 4 illustrates an exemplary XRF spectrometer system in accordance with some embodiments;

FIG. 5 illustrates one example of an environmental protective cover of a spectrometer in accordance with some embodiments;

FIG. 6 illustrates an exemplary block diagram of an electronic evaluation unit in accordance with some embodiments;

FIG. 7A illustrates an exemplary cooling system for a spectrometer in accordance with some embodiments;

FIG. 7B illustrates aspects of an exemplary cooling system for a spectrometer in accordance with some embodiments;

FIG. 8 illustrates a block diagram of an exemplary computing device of an XRF mapping spectrometer system in accordance with some embodiments;

FIG. 9 illustrates an exemplary control system displayed on a graphical user interface in accordance with some embodiments; and

FIG. 10 illustrates a block diagram of an exemplary method of XRF analysis in accordance with some embodiments.

While the present disclosure is susceptible to various modifications and alternative forms, specific embodiments have been shown by way of example in the drawings and will be described in detail herein. It should be understood, however, that the present disclosure is not intended to be limited to the particular forms disclosed. Rather, the present disclosure is to cover all modifications, equivalents, and alternatives falling within the spirit and scope of the disclosure as defined by the appended claims.

### DETAILED DESCRIPTION

This description of the exemplary embodiments is intended to be read in connection with the accompanying drawings, which are to be considered part of the entire written description. It should be understood, however, that the present disclosure is not intended to be limited to the particular forms disclosed and that the drawings are not necessarily shown to scale. Rather, the present disclosure covers all modifications, equivalents, and alternatives that fall within the spirit and scope of these exemplary embodiments. In the description, relative terms such as “lower,” “upper,” “horizontal,” “vertical,” “above,” “below,” “up,” “down,” “top,” and “bottom” as well as derivatives thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling, and the like, such as “connected” and “interconnected,” refer to a relationship wherein structures are secured or attached to one another either directly or indirectly through intervening structures, as well as both movable or rigid attachments or relationships, unless expressly described otherwise. The terms “couple,” “coupled,” “operatively coupled,” “operatively connected,” and the like should be broadly understood to refer to connecting devices or components together either mechanically, or otherwise, such that the connection allows the pertinent devices or components to operate with each other as intended by virtue of that relationship.

The present disclosure is directed to systems and methods for XRF spectrometric analysis. The analysis involves excitation of samples, detection of characteristic X-rays, analysis of such X-rays, and movement along multiple axes to map the X-ray intensities emanating and/or reflected from the surface of a sample. The analysis further includes using calibrated intensities from known reference materials, as well as standardless mathematical treatments based on fundamental parameters of the atomic elements detected during the analysis of the sample.

The present disclosure includes a mobile and automated mapping XRF spectrometer for hyperspectral elemental imaging and analysis of large samples that are inherently unsuitable for analysis with stationary laboratory instrumentation. Exemplary aspects of the disclosure concern unique and novel approaches to spectrometer design, integration, and automation that overcome limitations of prior art systems. The disadvantages of the prior art are overcome by a mobile XRF spectrometer of the present disclosure that is specifically configured for mapping or imaging X-ray fluorescence emitted by a large sample in response to incident X-ray radiation.

XRF systems and methods specifically for in situ XRF analysis are disclosed. These XRF systems and methods provide for X-ray fluorescence elemental imaging and mapping spectrometric measurements of the surfaces of large objects. Provided herein is an XRF analysis apparatus, which may include: (1) an X-ray source for excitation of a sample with a radiation beam; (2) an X-ray detector for detecting characteristic X-rays and scattered X-rays, and outputting a signal containing energy and intensity information on the characteristic X-rays and the scattered X-rays; (3) an analyzer for analyzing the signal; (4) a spectrometer stage assembly capable of moving an irradiation point relatively in X, Y, and Z-axes, with respect to the surface of a sample, within a Cartesian XY mapping area set in advance; and (4) an X-ray mapping processing section for: (a) discriminating an X-ray intensity corresponding to a specific element, (b) determining an intensity contrast in which a color or lightness is changed in accordance with the X-ray intensity, and (c) performing image display at a position corresponding to the XY irradiation point, in which the X-ray mapping processing section determines the intensity contrast of the X-ray intensity at the irradiation point by setting in advance the X-ray intensity calibrated using Least Squares or Lucas-Tooth Pine models with respect to reference materials in which components elements and concentrations are known as a reference. The calibration may be replaced or augmented using standardless mathematical treatments based on fundamental parameters of the atomic elements.

A mobile XRF spectrometer system described herein allows a user to analyze large objects at their normal location, i.e., in situ XRF analysis, in place of conventional XRF where the object is brought to the XRF spectrometer system. This is especially useful in the analysis of high strength alloy steels or materials where moving the sample to the spectrometer system may be difficult or impossible. For example, the systems and methods disclosed herein may apply to centerline segregation of manganese (Mn) in high strength steel slabs during the cooling process. During continuous casting of these specialty steel grades, alloying elements, such as Mn, often segregate along the centerline of slabs. An example of laboratory XRF instrumentation for a process of centerline segregation is disclosed in “Bridging the Gap: MXRF Technique Rapidly Maps Centerline Segregation” by Joydeep Sengupta, et al., Iron & Steel Technology, technical article 1, July 2017, the entirety of which is incorporated herein by reference. Use of a mobile XRF spectrometer system disclosed herein can be used during the steelmaking production environment as a process analyzer to provide feedback to plant operators during production. The mobile XRF spectrometer system allows analysis of the steel (and other materials) without the considerable temporal delay incurred with sample collection and conventional laboratory analyses.

One of ordinary skill in the art will understand that a mobile XRF spectrometer system disclosed herein may have many uses beyond just use in connection with the steelmaking production environment. For example, the mobile XRF spectrometer systems disclosed may be used to analyze other samples, such as various textiles (woven and non-woven), metals, alloys semi-conductor wafers, papers, plastics, and silicone just to provide a few non-limiting examples. The mobile XRF spectrometer systems disclosed may also be used in a variety of different industries, such as weapons manufacturing, archaeometry, archaeology, art, mining, refining, medical device manufacturing, aerospace, automotive, and electronics to provide a few non-limiting examples.

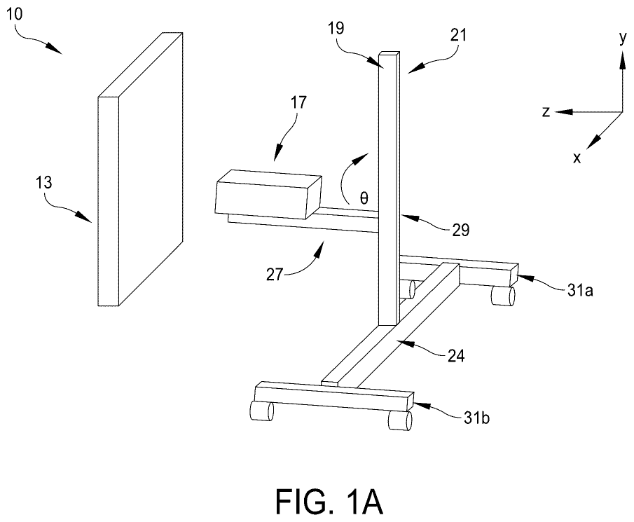

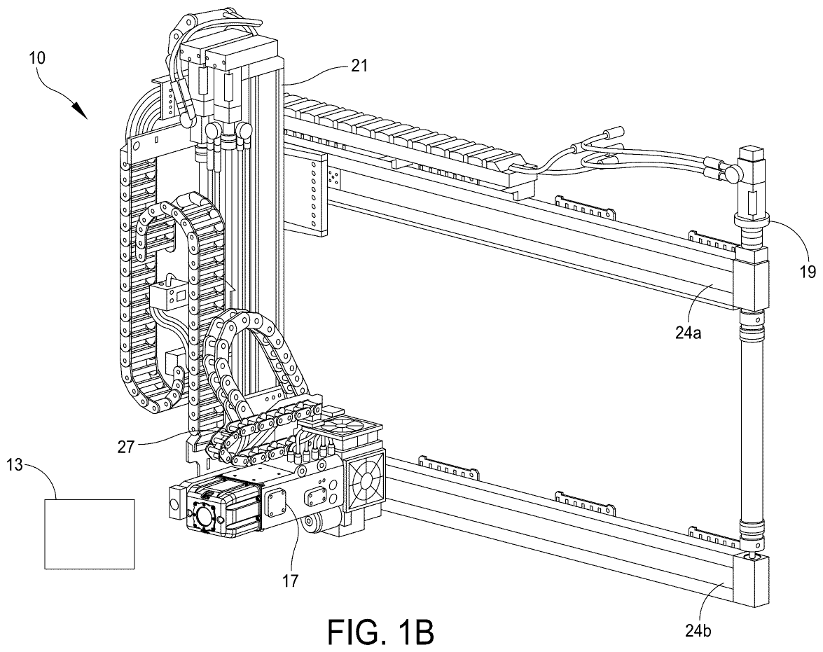

Referring now to the drawings, FIGS. 1A-1B illustrate examples of a mobile XRF mapping spectrometer system 10 in accordance with some embodiments. The XRF mapping spectrometer system 10 may provide for analysis of a sample 13. The XRF mapping spectrometer system 10 may include a spectrometer 17 that is mounted onto a stand 19 having a Cartesian geometry set of moveable stages. The spectrometer 17 may include motorized high precision linear stages situated adjacent to the sample 13. The stages of the stand 19 may include a Y-stage 21, an X-stage 24, and a Z-stage 27. The spectrometer 17 may be coupled to the Z-stage 27. The spectrometer 17 may be capable of scanning for XRF mapping by movements of a Y-stage 21, X-stage 24, and/or Z-stage 27. Although stand 19 is described as having a Cartesian geometry set, one of ordinary skill in the art will understand that stands having other coordinate sets (e.g., Polar coordinates)—similar to a c-arm used in medical imaging—may be implemented.

In some embodiments, two X-stages 24a-b may be employed as illustrated in FIG. 1B. The two X-stages 24a-b may be disposed parallel to each other to limit Y-stage 21 deflection from the vertical due to the high Z-axis moment arm from the mass of the spectrometer 17 on the Z-stage 27. In some embodiments, the X-stage 24 (or X-stages 24a-b) may be able to travel up to 1200 mm and the Y-stage 21 travel may be up to 1500 mm. In some embodiments, the Z-stage 27 may be able to travel up to 350 mm. However, one of ordinary skill in the art will understand that the X-stage 24 (or X-stages 24a-b), Y-stage 21, and Z-stage 27 may be otherwise configured to allow for greater or less travel. The stages may be moved by an actuator, such as the actuators disclosed in U.S. Pat. Nos. 10,800,315 and 11,110,844, the entireties of which are incorporated herein by reference.

The Z-stage 27 may be operatively linked to one or more proximity sensors, similar to position sensors 269 discussed in more detail below, located proximate to the spectrometer 17. The sensor data from the one or more proximity sensors may be used in real-time to maintain a uniform distance between the spectrometer 17 and the sample 13 resulting in a consistent illumination spot size on the sample 13 surface topography. The Z-stage 27 may be mounted on a rotational Θ-stage 29 to rotate the Z-stage 27 into a vertical position for compact storage of system 10, and to prevent damage to the spectrometer 17 during transport.

In some embodiments, the spectrometer 17 and associated system 10 may be mounted onto one or more movement features 31a-b as illustrated in FIG. 1A that allows the system 10 to be transported and/or repositioned. The one or more movement features 31a-b may be motorized to afford a self-transporting system and to allow for fine adjustments to positioning at the measurement site. In some embodiments, the one or more movement features 31a-b are a caster assembly, a track and tread assembly, wheels, or some other suitable feature capable of stabilizing and positioning the system 10 adjacent to the sample 13.

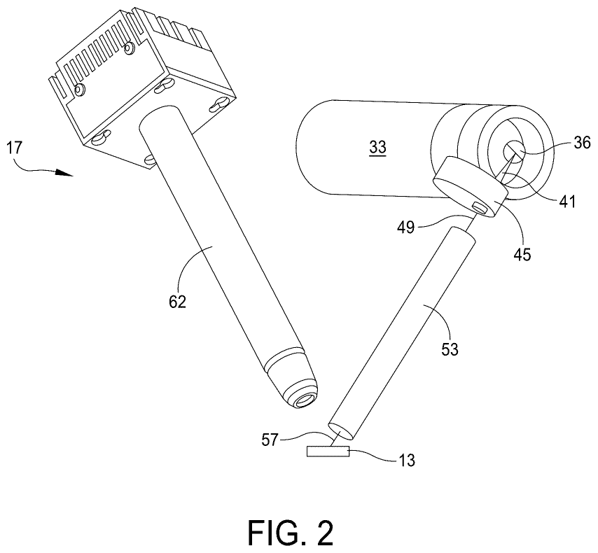

FIG. 2 illustrates aspects of an exemplary spectrometer 17 in accordance with some embodiments. The spectrometer 17 may be a meso- or micro-XRF spectrometer 17. The spectrometer 17 may include an X-ray tube 33 having an anode 36 designed to emit a divergent primary X-ray beam 41. The spectrometer 17 may also include a filtering foil system 45 operatively connected to the X-ray tube 33. The filtering foil system 45 may be configured to modify the primary X-ray beam 41 to produce a divergent X-ray beam with a modified X-ray beam 49. The filtering foil system 45 may be configured as a motorized revolving wheel, as illustrated in FIG. 2, and have multiple filtering materials. In other embodiments, the filtering foil system 45 may be a linear translation device containing a plurality of filtering materials. The filtering materials of the filtering foil system 45 may be metal, plastic, doped plastic coupons, or stacked foils of varying thicknesses, to provide only a few, non-limiting examples.

The spectrometer 17 may also include an optical system 53. The optical system 53 may be configured to receive the modified X-ray beam 49 and project a micro-scale or meso-scale X-ray beam 57 onto the surface of the sample 13. The optical system 53 may be a polycapillary optic or a multi-pinhole optical train. In some embodiments, an X-ray emission from the anode 36 resembles a point source. The spectrometer 17 may include either a double or triple pinhole optical train or a capillary lens, either of which may be configured to constrict the divergent X-ray beam to a small- or micro-diameter spot illuminating the surface of the sample 13. In some embodiments, the capillary lens may be a polycapillary lens. The focused and filtered primary radiation may pass through some path and interacts with the sample 13 before the resulting characteristic X-rays from the sample 13, along with scatter and other spectral artifacts, are recorded by one or more detectors 62 after passing through the path again. The path may be air, some gas (typically nitrogen or helium) or a partial vacuum. One example of a method for irradiating a sample using an X-ray beam to define a spot on a surface of a sample is disclosed in U.S. Pat. No. 7,653,174, the entirety of which is incorporated herein by reference.

As discussed above, the spectrometer 17 may be coupled to one or more movable stages, such as the movable stages illustrated in FIGS. 1A-B, capable of positioning the spectrometer 17 in the X, Y, and/or Z-directions. The micro-XRF or meso-XRF spectrometers (e.g., spectrometer 17) disclosed herein may incorporate an XY-stage to create elemental map images. For example, small-spot XRF mapping, such as meso-spot or micro-spot mapping, may be coupled with Cartesian geometry motorized high-precision stages (XY or XYZ, where Z is the distance from the X-ray source) that moves the spectrometer 17 across the sample 13 in a scanning pattern. By stepping or slewing the spectrometer 17 in a controlled way, multiple XRF spectra may be accumulated, where each spectrum is assigned to a specific pixel so as to form a two-dimensional (2D) map or image of a measured area. In this way, a data cube of 2D locations and their associated spectra are collected. Multiple map images of the sample 13, or portion of a sample 13, may be displayed on an element-by-element basis with different faux coloration per element. Colors may be assigned such that a brighter color is indicative of higher concentration of any given element. One example of a method of mapping for X-ray analysis is disclosed in U.S. Pat. No. 8,705,698, the entirety of which is incorporated herein by reference.

The spectrometers disclosed herein (e.g., spectrometer 17) may also include a Z-axis positioner or servo mechanism for real-time control of the spectrometer 17 to sample 13 surface distance as the XY-stages scan or otherwise image the sample 13 surface. Scanning modalities may include raster, serpentine, sinusoidal, rotational, spiral, cycloid, and Lissajous techniques. A r-θ stage may be substituted for the XY-stages, with subsequent transformation of coordinates back to Cartesian space for visualization of a map. One example of a scanning XRF spectrometer for measuring the content of a randomly distributed element contained in a sample is disclosed in U.S. Pat. No. 6,111,929, the entirety of which is incorporated herein by reference. One example of an X-ray analyzing apparatus capable of being rotated or shuttled to perform continuous scanning is disclosed in U.S. Pat. No. 6,404,847, the entirety of which is incorporated herein by reference.

Maintaining a constant Z-distance from the spectrometer 17 to the sample 13 maintains the diameter of the spot as a constant, thus creating a sharper and more consistent image with the prospect of superior quantitative and qualitative analyses from pixel to pixel.

The stages (e.g., X-stage 24, Y-stage 21, and Z-stage 27) may operate in the plane of the sample 13 and may facilitate movement of the spectrometer 17 using a scanning or stepping modality. For enhanced mapping capability, the stages may allow for movement in the Z-direction to adjust the sample 13 to spectrometer 17 distance, ensuring consistent distance is maintained from the surface of the sample 13. In some embodiments, the stages optionally employ linear motor actuators. In other embodiments, the stages use a r-θ stage or a multi-axis robotic system. One example of an X-ray analysis of a sample using a robot arm is disclosed in U.S. Pat. No. 9,547,094, the entirety of which is incorporated herein by reference. Although the system 10 disclosed herein is configured to move spectrometer 17 for XRF analysis, it will be appreciated that the system 10 could be configured to move the sample 13 instead.

The X-ray detectors 62 may be situated to measure characteristic X-ray fluorescence radiation emitted from the sample 13 in response to the incident X-rays (e.g., from X-ray beam 57). The X-ray detectors 62 may also measure portions of the reduced cross-section incident X-ray beam 57 scattered or diffracted by the sample 13. One example of an X-ray analysis apparatus capable of detecting characteristic X-ray and scattered X-ray is disclosed in U.S. Pat. No. 8,068,583, the entirety of which is incorporated herein by reference. The X-ray detector 62 may relay the associated detector signals to an electronic evaluation unit, described in further detail herein. One example of an XRF analyzer and method of analyzing a sample is disclosed in U.S. Pat. No. 6,108,398, the entirety of which is incorporated herein by reference.

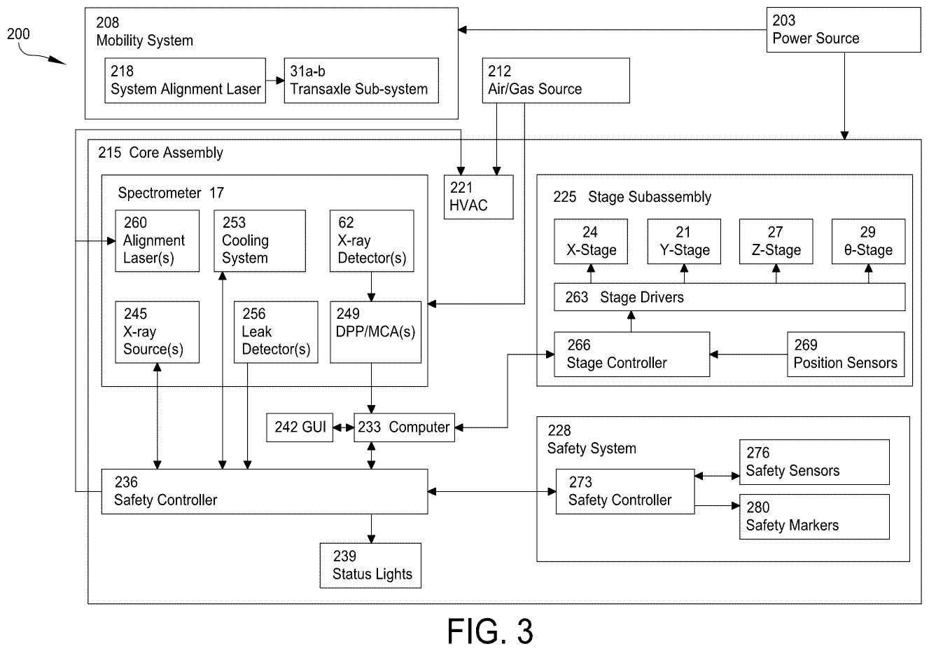

FIG. 3 illustrates a functional block diagram 200 of an exemplary mobile XRF spectrometer system 10 in accordance with some embodiments. The system 10 may include a power source 203, a mobility system 208, an air/gas source 212, and a core assembly 215. The power source 203 of the system, typically 100-240 VAC and 50 or 60 Hz, may be used to power and/or charge rechargeable batteries for a mobility system 208 and core assembly 215. The mobility system 208 may include a system alignment laser 218 used to guide operation of a motorized transaxle sub-system, or one or more movement features 31a-b. The system alignment laser 218 may be powered and/or recharged by power source 203 and physically connected to the core assembly 215 to move system 10. The system alignment laser 218 may be activated upon power up of the mobility system 208 to project a line onto the ground parallel to and at a set distance from the plane of the X-stage 24 and Y-stage 21. For example, the system alignment laser may project a line onto the group at a distance of 0.5-2 meters from the plane of the X-stage 24 and Y-stage 21. The system alignment laser 218 may be deactivated upon power down of the mobility system 208.

The core assembly 215 may include a spectrometer 17, a heating, ventilation, and air conditioning (HVAC) system 221, a stage assembly 225, a safety system 228, a computer 233 or other suitable computing device, and a controller 236. Gas sources 212 may be used to power aspects of the heating, ventilation, and air conditioning (HVAC) system(s) 221 and to provide positive pressurization to aspects of the core assembly 215 as controlled by the system controller 236. For example, dry shop air (e.g., 100 psig) may be employed to power a thermostatically regulated Vortex-style refrigeration system to cool aspects of the core assembly 215. Gas sources 212 may also provide dry shop air (e.g., 100 psig) to pass through a dryer, and regulated to 5 psig to pressurize the spectrometer 17 to prevent entry of environmental particulates and gases. In some embodiments, helium gas (He_{(g)}) may be employed as a continuous purge around X-ray detectors 62 and between the spectrometer 17 and sample 13 to provide enhanced sensitivity for low atomic number elements (e.g., sodium through calcium) and to eliminate the atmospheric argon (Ar_{(g)}) lines in the XRF spectrum. In other embodiments, nitrogen gas (N_{2(g)}) may be employed as a continuous purge around the X-ray detectors 62 and between the spectrometer 17 and sample 13 to eliminate the atmospheric argon (Ar_{(g)}) lines in the XRF spectrum.

Aspects of one or more HVAC 221 components spanning, but not limited to, the technologies described herein are controlled by one or more subsystems of the system controller 236 to maintain a stable nominal operating temperature range for the spectrometer 17 and its components. In some embodiments, resistive heater cores are employed in parts/components of the core assembly 215 to maintain a stable operating temperature range.

The core assembly 215 may include the bulk of the X-ray fluorescence analysis apparatus. For example, the core assembly 215 may include the spectrometer 17, the HVAC system 221, the stage assembly 225, the system controller 236, the safety system 228, one or more status lights 239, the computer 233, and a graphical user interface (GUI) 242.

The spectrometer 17 may include at least one X-ray source 245, one or more X-ray detectors 62 connected to one or more digital pulse processors and multi-channel analyzers (DPP/MCA) 249, a cooling system 253 with integrated leak detector(s) 256, and at least one alignment laser 260. In some embodiments, the X-ray detector 62 may be connected to DPP/MCA(s) 249 via a 5002 coaxial cable(s) no more than 45 cm in length. The resulting processed spectra for each pixel may be passed to the computer 233 via a single universal serial bus (USB) cable. It will be appreciated that the resulting processed spectra for each pixel may be passed to the computer 233 via a wired or wireless fieldbus or Modbus protocol instead of a USB cable. Power, voltage (kV), and current (μA) for X-ray source(s) 245 may be controlled and monitored by one or more subsystems of the system controller 236 as set by the computer 233 through the GUI 242. The cooling system 253 and associated leak detector(s) 256 are controlled and monitored by the system controller 236 as set by the computer 233 through the GUI 242. The at least one alignment laser 260 is controlled by the system controller 236 as set by the computer 233 through the GUI 242 to define the upper left Cartesian start position (X1, Y1) vertex and lower right Cartesian end position (X2, Y2) vertex that defines a rectangular map area as discussed in more detail below.

The stage assembly 225 may include the X-stage 24, Y-stage 21, Z-stage 27, and an optional rotational Θ-stage 29. The X-stage 24, Y-stage 21, Z-stage 27, and Θ-stage 29 may be powered by one or more stage driver 263 assemblies. The one or more stage driver 263 assemblies may be controlled by a stage controller 266 in conjunction with a plurality of position sensor 269 data and operating instructions from the computer 233 in conjunction with the GUI 242. The position sensors 269 may be controlled by the stage controller 266 as set by the computer 233 through the GUI 242. The position sensors 269 may measure and set the desired distance at the upper left Cartesian start position (X1, Y1, Z1) vertex and lower right desired distance at the Cartesian end position (X2, Y2, Z2) vertex that defines a rectangular map area on the sample 13.

The position sensors 269 may measure and set the desired distance at four Cartesian points on the sample 13. For example, the position sensors 269 may set an upper left (X1, Y1, Z11), a lower left (X1, Y2, Z12), an upper right (X2, Y1, Z21), and a lower right (X2, Y2, Z22) vertices, that define a rectangular map plane. In some embodiments, the X and Y Cartesian coordinates define a rectangular map set by the computer 233 through the GUI 242 with the aid of an optical camera and spot laser embedded as part of the spectrometer 17 position sensors 269. The laser beam may be parallel to the X-ray source 245 beam and offset by a known distance for which the computer 233 automatically compensates to place the X-ray source 245 beam at the coordinates defined with the laser beam on the surface of a sample 13.

In some embodiments, the position sensors 269 may be controlled by the stage controller 266 as set by the computer 233 through the GUI 242 to measure and set the desired distance at two Cartesian points on the sample 13, the midpoint between the upper left (X1, Y1, Z11) and lower left (X1, Y2, Z12) vertices coordinates, as well as the midpoint between the upper right (X2, Y1, Z21) and lower right (X2, Y2, Z22) vertices coordinates, that define a line on a rectangular map plane. The Z-stage 27 may be driven by the computer 233 and stage controller 266 through the stage driver 263 to the Z value of a line in Cartesian space extrapolated by the computer 233 between the two midpoints.

In some embodiments, position sensor 269 may be controlled by the stage controller 266 as set by the computer 233 through the GUI 242 to measure and set the desired distance at two Cartesian points on the sample 13, the midpoint between the upper left (X1, Y1, Z11) and upper right (X2, Y1, Z21) vertices coordinates as well as the midpoint between the lower left (X1, Y2, Z12) and lower right (X2, Y2, Z22) vertices coordinates, that define a line on a rectangular map plane.

In some embodiments, the extrapolated plane for determining Z-stage 27 position may assume that at coordinate (X1, Y2) the Z value corresponds to Z1 and at coordinate (X2, Y1) the Z value corresponds to Z2. In some embodiments, the extrapolated plane for determining Z-stage 27 position may assume that at coordinate (X1, Y2) the Z value corresponds to Z2 and at coordinate (X2, Y1) the Z value corresponds to Z1. The Z-stage 27 may be adjusted based on the desired distance determined from two midpoints of Cartesian coordinates, either from the upper left (X1, Y1, Z11) to lower left (X1, Y2, Z12) or from the upper right (X2, Y1, Z21) to lower right (X2, Y2, Z22).

In some embodiments, software control of the stage (e.g., X-stage 24, Y-stage 21, Z-stage 27, Θ-stage 29) setup may be performed wirelessly by employing a tablet computer that is paired with and logically part of the computer 233, via either Bluetooth, Wi-Fi, and/or other public or proprietary wired or wireless protocol for example, where the GUI 242 is internal to the tablet computer.

In some embodiments, the computer 233, through the GUI 242, can be preconfigured with a plurality of Cartesian map coordinates or regions. The computer 233, through the GUI 242, may automatically map the plurality of regions on a large sample, such as sample 13, or a plurality of regions on a stack or an array of smaller samples.

The system 10 may also include a safety system 228 that includes a safety controller 273 communicating with one or more safety sensors 276, and controlling safety markers 280. The safety controller 273 may be in bi-directional communication with the system controller 236 and subsequently with the computer 233 and its GUI 242. The safety controller 273, at power-up or software boot, activates a plurality of line-type laser safety markers 280. The safety markers 280 may include at least one on either side of the core assembly 215 that are configured to shine or project at the ground defining a visual exclusion zone at some set distance from the sides of the system 10 and parallel and/or perpendicular to the spectrometer 17 and its X-ray source 245 beam. In some embodiments, upon software boot the safety controller 273 may energize a plurality of motion activated safety sensors 276. These motion-activated safety sensors 276 may include at least one on either side of the system 10 that have a large defined field-of-view. Upon encroachment closer than some set distance from either side of the assembly, the safety controller 273 may be triggered to notify the system controller 236 to immediately shut off the X-ray source 245 as well as report the action to the computer 233 to stop stage(s) movements (e.g., X-stage 24, Y-stage 21, Z-stage 27, and/or Θ-stage 29), change the status lights 239, and update the GUI 242. As an example, the visual exclusion zone may be at 0.5-2 meters from the system 10. As a further example, the safety sensors 276 may have a 60-70 degree field of view.

The system controller 236 may be regulated by the computer 233. The system controller 236 may provide logic sensing and control of one or more status lights 239 that include status of the core assembly 215, such as the HVAC system 221, as well as aspects of the spectrometer 17 to include: alignment lasers 260, X-ray source 245, cooling system 253, and leak detectors 256. In some embodiments, status lights 239 are a vertical stack of a plurality of lights containing at least a red light at the top of the stack indicating X-rays are on when illuminated, an amber light in the center of the stack indicating stage movement when illuminated, and a green light at the bottom of the stack indicating system readiness when illuminated. The green status light may extinguish when the red “X-rays on” light is illuminated and may re-illuminate when “X-rays on” light is extinguished. In some embodiments, the system controller 236 and computer 233 are connected to a mechanical emergency stop button, through the safety system 228 and on the main control panel, to immediately stop X-rays and stage motion if needed.

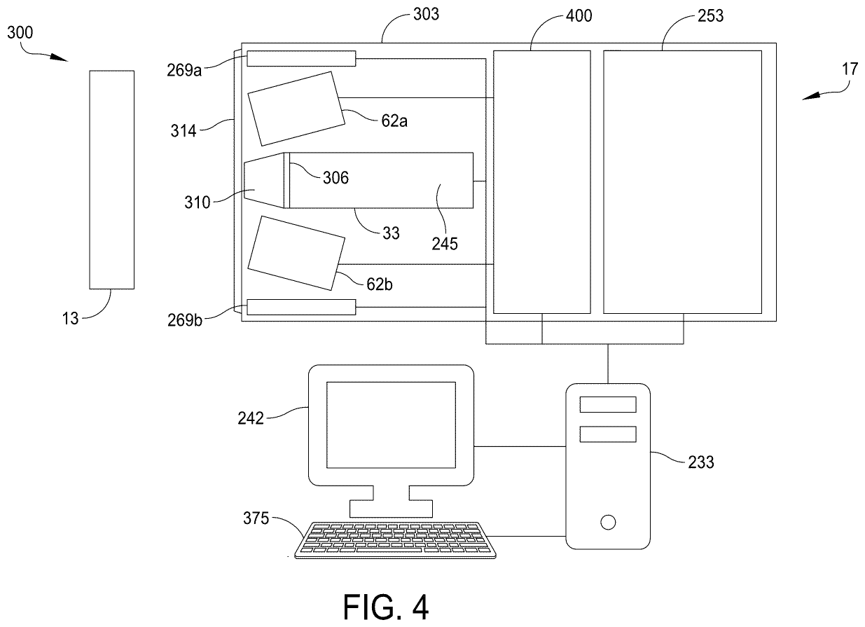

FIG. 4 illustrates one example of an exemplary XRF spectrometer system 300 in accordance with some embodiments. The XRF spectrometer system 300 may include a sealed spectrometer case assembly 303 for spectrometer 17. For example, spectrometer case assembly 303 may be gasketed throughout to ensure a hermetic seal. In some embodiments, the sealed spectrometer case assembly 303 may be equipped with a dry air, helium gas (He_{(g)}), or dry nitrogen gas (N₂) purge, to maintain a slight positive pressure within the spectrometer case assembly 303 to preclude entry of dust, dirt, or moisture.

The XRF spectrometer system 300 may also include the X-ray source 245. The X-ray source 245 may include one or more X-ray tube(s) 33 and a motorized selector 306 for a plurality of metal and/or plastic foil X-ray filters 45. The motorized selector 306 may be positioned between X-ray tube 33 and an optical assembly 310 to modify the X-ray radiation output and achieve better sensitivity for certain elements present in the sample 13. The X-ray beam optical assembly 310 may generate an X-ray beam 57, of defined divergence or convergence, illuminating the sample 13 with a round or ellipsoidal X-ray spot of micro-scale or meso-scale proportions.

The X-ray tube 33 may be a low power (4-12 W), end-window, transmission target design emitting a highly parallelized X-ray beam suitable for close coupling with a variety of X-ray beam optical assemblies 310 with minimal mass and small physical dimensions. In other embodiments, the X-ray tube 33 may be a medium power (50-150 W), microfocus type with a beryllium (Be) exit window and an approximately round emission spot on the anode 36, suitable for close coupling with a variety of X-ray beam optical assemblies 310.

The X-ray beam optical assembly 310 may include a plurality of pinhole apertures separated by some fixed or adjustable spacings so as to project a pencil beam of X-rays consisting of Bremßtrahlung (polychromatic) radiation and characteristic X-ray lines from the anode 36 material. In other embodiments, X-ray beam optical assembly 310 may include a two-dimensional reflection system. For example, the X-ray beam optical assembly 310 may include a compact arrangement of two X-ray multi-layer mirrors in a “side-by-side” Kirkpatrick-Baez (Osmic) or Montel-type scheme, where the mirrors and constrained angles are tailored to the anode 36 material so as to satisfy the Bragg Equation and pass a focusing or parallel beam of monochromatic X-ray light. In some embodiments, the optical assembly 310 may be one of Rigaku's Confocal Max-Flux® (CMF) optics. In some embodiments, the optimal X-ray source 245 to sample 13 distance is a function of the type of X-ray beam optical assembly 310 and the desired map pixel size.

The sealed spectrometer case assembly 303 may be fitted with an X-ray transparent window 314 to facilitate a sealed operating environment for the spectrometer 17. The X-ray transparent window 314 may be a spectroscopy grade film or foil no more than a few microns thick. In some embodiments, the X-ray transparent window 314 may be a plastic film coated with a thin shiny metallized film to inhibit transmission of infrared (IR) light into the spectrometer case assembly 303. In some embodiment, the X-ray transparent window 314 coating would be metallic aluminum (Al), or some other metal based on the application, with a thickness of between 1 nm and 10 μm. In further embodiments, X-ray transparent window 314 may be a pure metal foil, typically, but not necessarily, aluminum (Al), and may be 10-35 μm thick to reject infrared radiation and attenuate unwanted low energy X-rays (in the case of aluminum).

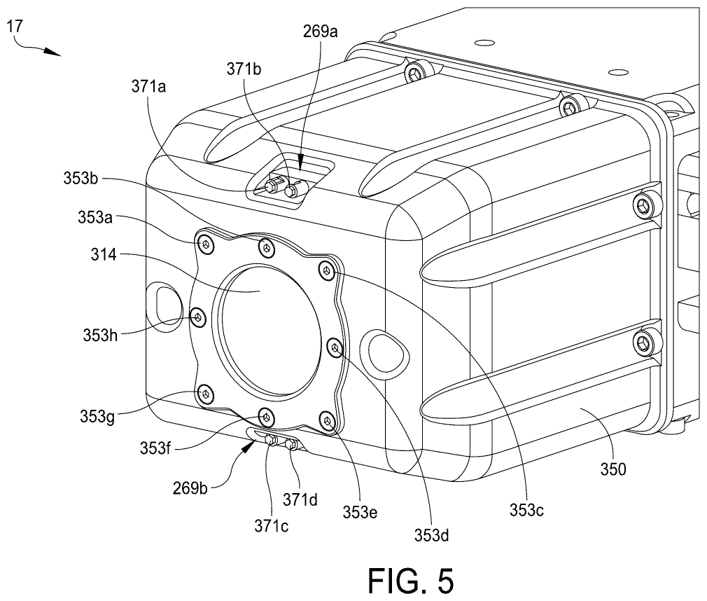

FIG. 5 illustrates one example of an environmental protective cover 350 of the spectrometer 17 in accordance with some embodiments. The cover 350 may enclose the operating end of the spectrometer 17 to protect the internal components as illustrated in FIG. 4. The operating end of the cover 350 may include the X-ray transparent window 314. The cover 350 also may include one or more fasteners 353a-h, such as screws, that facilitate removal and replacement of X-ray transparent window 314. The spectrometer 17 may also include one or more position sensors 269a-b (e.g., position, proximity, distance, and/or edge detection sensors) disposed on the cover 350 that are configured to determine the distance between the spectrometer 17 and the sample 13. These position sensors 269a-b may include a transmitter 371a,c and a receiver 371b,d configured to measure the environment around the spectrometer case assembly 303 and between the spectrometer 17 and the sample 13.

Referring back to FIG. 4, the position sensors 269a-b are communicatively coupled to the computer 233, which processes the signals from the position sensors 269a-b. The position sensors 269a-b may be based on one or more of the following technologies: capacitive, radar, photoelectric, laser rangefinder, ultrasonic, inductive, Hall effect, time-of-flight camera, Doppler effect, LED, LiDAR, VCSEL, fiber optic and capacitive displacement. In some embodiments, the position sensors 269a-b may include at least one ultrasonic distance sensor with a resolution greater than 0.069 mm and a repeatability of ±0.15%. The examples of position sensors 269a-b are merely examples and a person of ordinary skill in the art will appreciate other types of position sensors 269 are possible.

The spectrometer 17 may include one or more energy dispersive X-ray detectors 62a-b. These X-ray detectors 62a-b may be situated within the spectrometer case assembly 303 to measure characteristic X-ray fluorescence radiation emitted from the sample 13 in response to the incident X-rays and portions of the reduced cross-section incident X-ray beam scattered or diffracted by the sample 13. The X-ray detectors 62a-b may be arranged in an annular pattern about the X-ray source 245. The X-ray detectors 62a-b may be solid state thermoelectrically (Peltier) cooled devices. For example, the X-ray detectors 62a-b may be any combination of the silicon drift detector (SDD) type, the cadmium telluride (CdTe) type, and/or the PIN-diode type. In some embodiments, the X-ray detectors 62a-b are of the gas proportional counter (PC) type.

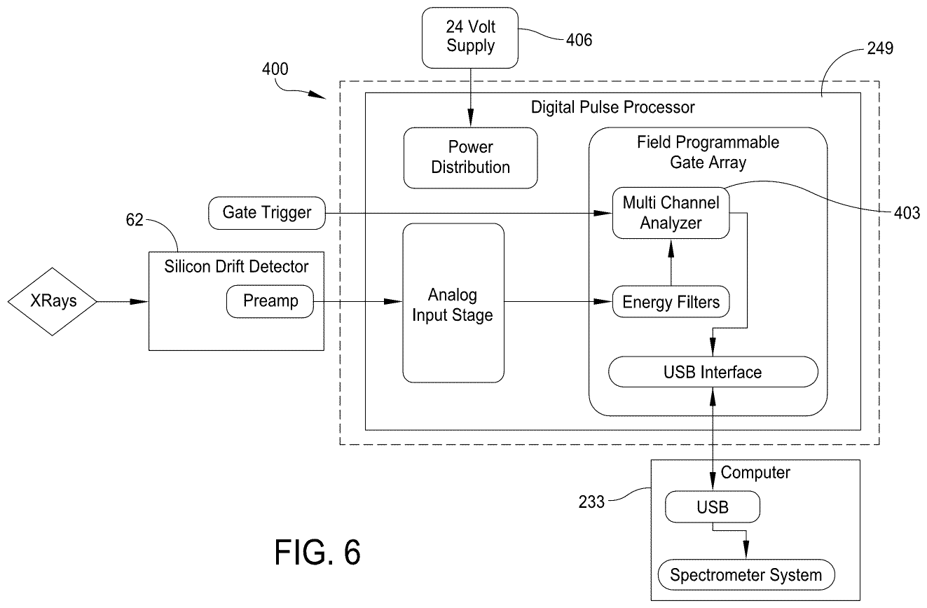

The spectrometer 17 may also include an electronic evaluation unit 400 configured to receive detector 62a-b signals from the X-ray detectors 62. FIG. 6 illustrates an exemplary block diagram of an electronic evaluation unit 400 in accordance with some embodiments. The electronic evaluation unit 400 may provide for signal processing of the detected X-rays. The electronic evaluation unit 400 may include a discrete digital pulse processor (DPP) 249 for each X-ray detector 62a-b. The DPP 249 may be used to digitize the electrical signals from the X-ray detectors 62a-b. The DPP 249 may also include a multi-channel analyzer (MCA) 403, which may be configured to categorize the energy of X-rays detected by the X-ray detectors 62a-b resulting in an output of counts (intensity) by X-ray energy by pixel transmitted to the computer 233. In some embodiments, the electronic evaluation unit 400 may include a discrete power supply 406 with Peltier cooling, as discussed in more detail below, for X-ray detectors 62. It will be appreciated that the electronic evaluation unit 400 may include additional components, such as an input/output board to interact with the electronic evaluation unit 400 directly and a beam controller configured to control the X-ray beam 57. Although electronic evaluation unit 400 is within spectrometer case assembly 303, it will be appreciated that the electronic evaluation unit 400 may be remote from the spectrometer case assembly 303.

Referring again to FIG. 4, the spectrometer 17 may also include a cooling system 253. The cooling system 253 may include technology to remove excess heat generated by the X-ray source 245, X-ray detector(s) 62a-b, position sensor(s) 269a-b, and the electronic evaluation unit 400 by thermally coupling some or all of the components to a cooling fluid as will be discussed in further detail below.

The XRF spectrometer system 300 may also include the computer 233 having a plurality of processing components to monitor, control, and/or log the processes of the components (e.g., X-Ray source 245, X-ray detectors 62a-b, sensors 269a-b, electronic evaluation unit 400, cooling system 253, etc.) within the spectrometer case assembly 303. The computer 233 may be configured to run analytical software to receive an input from an input/output device 375 or drive GUI 242. The computer 233 may be at least one industrial process computer (IPC) and at least one programmable logic controller (PLC). In exemplary aspects, the IPC can be an industrial grade computer, and the system operator can interface with the IPC through the GUI 242. In some embodiments, GUI 242 may be a touch screen graphical user interface.

The computer 233 may be configured to perform a variety of functions facilitated by the communication throughout the XRF spectrometer systems disclosed herein. Such functions may include: (1) monitoring for loss of power and halting control functions when a power loss is detected while still providing cooling until backup power is exhausted; (2) controlling system 10 restart using operator confirmation after reestablishing power; (3) signaling a shutdown command if an uninterruptible power supply (UPS) indicates backup power is exhausted; (4) performing a shutdown when the UPS indicates backup power is exhausted; (5) interfacing with the PLC by operating as a master, which enables communication among many devices connected to the same network; (6) monitoring activation of the PLC over industrial network communications to determine if communications are established and operating; (7) halting control functions when a PLC communications loss is detected; (8) processing logic to indicate activation or readiness of the IPC over industrial network communications; (9) reading/writing status data to one or more PLC subordinate registers during cycle operations; (10) interfacing with stage controller 266 of the stage assembly 225 by operating as a subordinate; (11) monitoring a connection with the stage controller 266 and halting control functions when a communications loss is detected; (12) reading and writing values into an interface block that reads and writes from the stage controller 266; (13) interfacing with a user through the GUI 242 to indicate status of the system 10; (14) interfacing with a user through the input/output device(s) 375 and GUI 242 to collect and authenticate login credentials and set application privileges; (15) interfacing with the user through the GUI 242 to collect information required by the system 10 during setup operations; (16) interfacing with the spectrometer 17 to query, configure, and command the system 10 during cycle operations; (17) interfacing with a central database to retrieve information required by the system 10 during startup, setup, and cycle operations; (18) interfacing with the memory to store information collected by the system 10 during startup, setup, and cycle operations; (19) interfacing with the memory to perform database maintenance functions; (20) processing XRF data using calibration files stored in the memory; (21) securing the X-ray source 245 when the position sensors 269 no longer detect the sample 13; and (22) securing or not energizing the X-ray source 245 in the event that the X-ray warning light is not energized during operation, just to provide a few non-limiting examples.

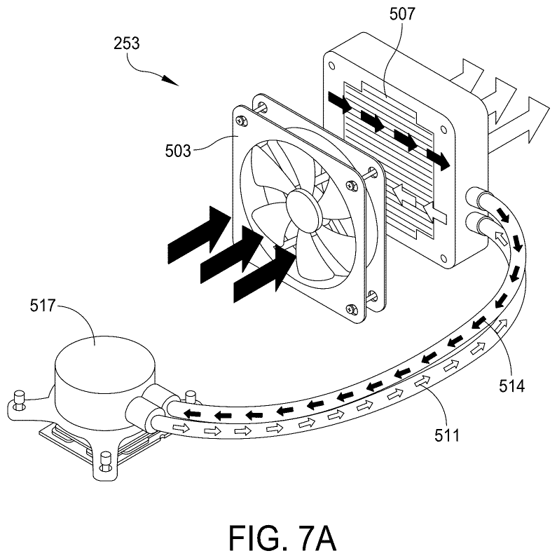

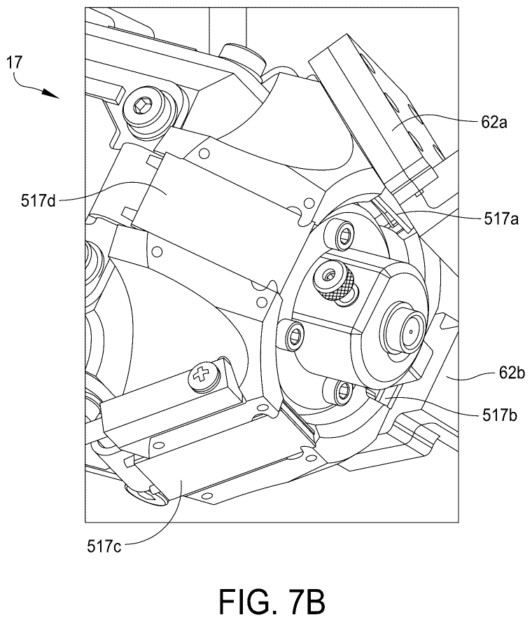

FIGS. 7A-7B illustrate one example of a cooling system 253 of the spectrometer 17 in accordance with some embodiments. As illustrated in FIG. 7A, the cooling system 253 may include a liquid cooling system, such as a closed-loop dry cooling type system, having a fan 503, a plurality of rows of finned tubes 507, a hot side 511, a cold side 514, and one or more thermoelectric (e.g., Peltier) cooling devices 517. The transfer of the heat is facilitated by hot coolant fluid on the hot side 511 flowing from the cooling device 517 to the plurality of rows of finned tubes 507. Ambient air is forced through the finned tubes 507 with the fan 503. The colder coolant is then transferred through the cold side 514 back to cooling device 517 cooling components of the spectrometer 17.

In some embodiments, the cooling system 253 may include a plurality of cooling devices 517, where each cold side 514 is directly coupled to some or all of components within the spectrometer case assembly 303. For example, as illustrated in FIG. 7B, each of the X-ray detectors 62a-b may be cooled by these Peltier cooling devices 517a-d disposed under the X-ray detectors 62a-b. It will be appreciated that the spectrometer 17 illustrated in FIG. 7B has X-ray detectors 62c-d removed from the drawing to show the cooling devices 517c-d.

In other embodiments, cooling system 253 may include other single-phase liquid cooling technologies like liquid-to-liquid, open-loop evaporative, closed-loop evaporative, and external chilled water. In a further embodiment, the cooling system 253 may include two-phase cooling through either passive heat pipe or active Carnot cycle system. In this embodiment, the excess heat is removed from the hot side by conduction to fins, similar to the finned tubes 507 discussed above, coupled with forced ambient air heat dissipation by the fins.

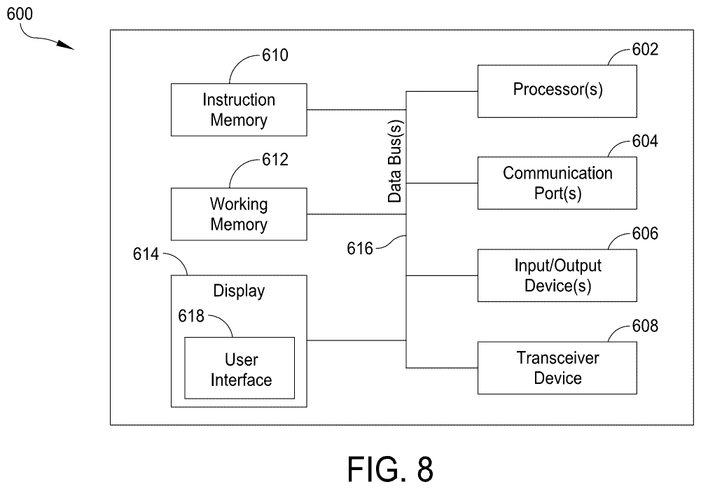

FIG. 8 illustrates a block diagram of an exemplary computing device 600 of a XRF spectrometer system disclosed herein in accordance with some embodiments. The computing device 600 can be employed by a disclosed system or used to execute a disclosed method of the present disclosure. For example, computing device 600 may be computer 233, system controller 236, or any other computing device described herein. Computing device 600 may be configured to operate any of the systems illustrated in FIGS. 1A-7B. It should be understood, however, that other computing device configurations are possible.

Computing device 600 can include one or more processors 602, one or more communication port(s) 604, one or more input/output devices 606, a transceiver device 608, instruction memory 610, working memory 612, and optionally a display 614, all operatively coupled to one or more data buses 616. Data buses 616 allow for communication among the various devices, processor(s) 602, instruction memory 610, working memory 612, communication port(s) 604, and/or display 614. Data buses 616 can include wired, or wireless, communication channels. Data buses 616 are connected to one or more devices.

Processor(s) 602 can include one or more distinct processors, each having one or more cores. Each of the distinct processors 602 can have the same or different structures. Processor(s) 602 can include one or more central processing units (CPUs), one or more graphics processing units (GPUs), application specific integrated circuits (ASICs), digital signal processors (DSPs), and the like.

Processor(s) 602 can be configured to perform a certain function or operation by executing code, stored on instruction memory 610. For example, processor(s) 602 can be configured to perform one or more of any function, method, or operation disclosed herein.

Communication port(s) 604 can include, for example, a serial port such as a universal asynchronous receiver/transmitter (UART) connection, a Universal Serial Bus (USB) connection, or any other suitable communication port or connection. In some examples, communication port(s) 604 allows for the programming of executable instructions in instruction memory 610. In some examples, communication port(s) 604 allow for the transfer, such as uploading or downloading, of data. In some embodiments, a wired or wireless fieldbus or Modbus protocol may be used.

Input/output devices 606 can include any suitable device that allows for data input or output, such as input/output device 375 illustrated in FIG. 4. For example, input/output devices 606 can include one or more of a keyboard, a touchpad, a mouse, a stylus, a touchscreen, a physical button, a speaker, a microphone, or any other suitable input or output device.

Transceiver device 608 can allow for communication with a network, such as a Wi-Fi network, an Ethernet network, a cellular network, radio signals, Bluetooth, or any other suitable communication network. For example, if operating in a cellular network, transceiver device 608 is configured to allow communications with the cellular network. Processor(s) 602 is operable to receive data from, or send data to, a network via transceiver device 608.

Instruction memory 610 can include an instruction memory 610 that can store instructions that can be accessed (e.g., read) and executed by processor(s) 602. For example, the instruction memory 610 can be a non-transitory, computer-readable storage medium such as a read-only memory (ROM), an electrically erasable programmable read-only memory (EEPROM), flash memory, a removable disk, CD-ROM, any non-volatile memory, or any other suitable memory with instructions stored thereon. For example, the instruction memory 610 can store instructions that, when executed by one or more processors 602, cause one or more processors 602 to perform one or more of the operations of the systems disclosed herein.

In addition to instruction memory 610, the computing device 600 can also include a working memory 612. Processor(s) 602 can store data to, and read data from, the working memory 612. For example, processor(s) 602 can store a working set of instructions to the working memory 612, such as instructions loaded from the instruction memory 610. Processor(s) 602 can also use the working memory 612 to store dynamic data created during the operation of computing device 600. The working memory 612 can be a random access memory (RAM) such as a static random access memory (SRAM) or dynamic random access memory (DRAM), or any other suitable memory.

Display 614 is configured to display user interface 618. User interface 618 can enable user interaction with computing device 600. In some examples, a user can interact with user interface 618 by engaging input/output devices 606. In some examples, display 614 can be a touchscreen, where user interface 618 is displayed on the touchscreen. To provide a couple examples, display 614 may provide GUI 242 and tablet screen as described herein.

### Exemplary Method of Use

Operation of a mobile XRF spectrometer system 10 entails moving the unit 10 from its storage location to the process measurement location. To accomplish this, first, the movement features 31a-b must be unlocked, such as the casters illustrated in FIG. 1A. Power source 203, which is used to charge various batteries, is disconnected. The movement features 31a-b are then powered up on battery power, at which time the system alignment laser 218 is illuminated to shine a line on the ground at a set distance from the stand 19. Control of the movement features 31a-b is entirely independent from the rest of the system 10. In addition to a key switch to power up the movement features 31a-b, controls may also include backwards and forwards variable motor control, an emergency stop button which activates an electromagnetic brake, a horn button, and battery level indicator. Maneuvering the stand 19 may also be manually achieved by employing the strength of a user. In some embodiments, the stand 19 may be capable of climbing 0-10 degree grades.

After disconnecting the power source 203 and enabling remote power of the stand 19 (i.e., through one or more batteries), a user may employ body kinetics and stand 19 propulsion to maneuver the stand 19 down a plurality of paths and/or grades to reach some level measuring pad or platform. The stand 19 may be further maneuvered such that the system alignment laser 218 line is parallel to and touching the bottom of a sample 13, such as a stack of steel slabs, to be mapped by XRF. Once aligned, the stand 19 is powered off and the movement features 31a-b are locked to prevent translation and rotation.

Attaching the power source 203 may be required if the one or more batteries are not sufficient. The method may also include connecting dry shop air (e.g., 100 psig shop air) via a quick disconnect. The system 10 may also include additional mechanical filter/dryer along with a splitter for a pressure regulator and gauge assembly to supply 5 psig air to the spectrometer case assembly 303 for cooling and to preclude entry of dust and debris into the spectrometer case assembly 303. Most of the shop air may be fed to a thermostatically controlled solenoid valve that feeds a Vortex chiller supplying cold air to the spectrometer case assembly 303 housing the internal electronics. A combination of the Vortex chiller and a thermostatically controlled heater block maintain the spectrometer case assembly 303 contents at a constant temperature. Similarly, the spectrometer 17 may have a thermostatically regulated cartridge heater to assist in maintaining a set temperature during cold atmospheric conditions.

Turning the key, proximate to the GUI 242 display screen, activates the system 10 and the green status light 239. Following logging into a Microsoft Windows™ operating system, or other suitable computer operating system, the user starts the system 10 software, selects user privileges category, and enters the appropriate password to gain access. The user will follow the various maintenance and safety prompts, then check system status for detectors 62a-b, X-ray source 245, relevant system 10 temperatures, and stages (e.g., X-stage 24, Y-stage 21, Z stage 27, and Θ-stage 29).

To initiate an elemental XRF map of a sample 13, such as a steel slab within a stack of slabs, the system 10 may perform an initial setup and place all safety interlocks into a ready state. At this point, the user should identify which slab or slabs in the stack are to be mapped.

Within the GUI 242, the user may press a button to rotate the spectrometer 17 from a vertical storage position to a horizontal measuring position. This rotation is part of an X-ray interlock, so that the X-ray source 245 cannot be energized in the vertical position. Other X-ray source interlocks may include safety sensors 276, stage overcurrent, X-ray safety markers 280, coolant leak detectors 256, position sensors 269 (e.g., to measure distance from the sample 13), and anti-collision sensors, which may be included in or discrete from position sensors 269. If any of these interlocks throw an error condition, the X-ray source 245 and all stage movement is immediately deactivated. It will be appreciated that in some embodiments, the system 10 may include a plurality of position, proximity, distance, and edge detection sensors.

Next the user may optionally initialize a wireless tablet computer for remote control if desired. Measurement setup may be performed on the main GUI 242 display or the tablet GUI 242 display. For each sample 13, one or more maps may be defined and multiple samples 13 may be predefined prior to starting data acquisition.

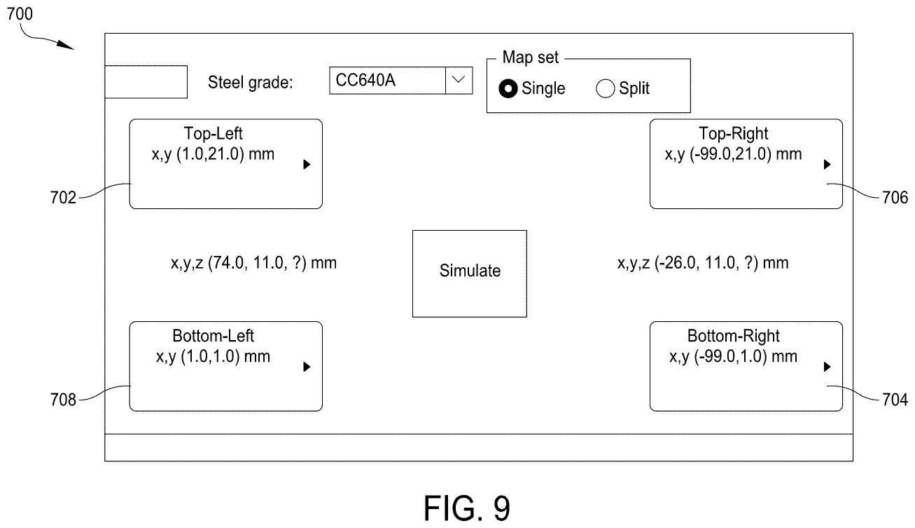

To define a rectangular map, the user visualizes and sets the corners of the sample 13. FIG. 9 illustrates an exemplary control system 700 displayed on a GUI 242 in accordance with some embodiments. A user sets at least two corners of the sample 13, usually the upper left 702 and lower right 704, but the user may also set the top right 706 and lower left 708 of the sample 13. The user will set the corners 702, 704, 706, and/or 708 by jogging the spectrometer 17 left and right or up and down while watching the position of the alignment laser 260 on the surface of the sample 13. The alignment laser 260 spot defines the analysis position of the X-ray source 245. While the alignment laser 260 is slightly offset from the X-ray source 245, this offset may be automatically compensated by the computer 233. When using the tablet computer 233, the user may stand to one side of the system 10 to directly view the alignment laser 260; otherwise, a spectrometer 17 mounted camera may provide a video image within the GUI 242 environment (e.g., either on a main computer GUI 242 or tablet GUI 242).

For each map, the space between the spectrometer 17 and the sample 13 (Z spacing) is automatically measured and set (Z calibration). This measurement is performed by the computer 233 in conjunction with the position sensors 269 mounted in the spectrometer case assembly 303, the Z-stage 27 and its stage controller 266 and driver 263, and the optimal predefined value to achieve the desired X-ray source 245 spot size corresponding to the desired map pixel size. This process involves driving the spectrometer 17 Z-spacing in and/or out relative to the sample 13 while simultaneously measuring the Z-spacing with the position sensors 269 to find and set the Z-value at two or more positions so as to define and extrapolate an XYZ plane for mapping.

Clicking on the acquire button, either on the main or tablet GUI 242, activates the X-ray source 245 for warmup, activates the red status lights 239, and begins the automatic Z calibration. Once the Z calibration has been completed, the elemental mapping protocol begins. Once the raw intensity map data has been collected from the elemental mapping protocol, the computation of the corresponding quantitative map begins and is displayed upon completion. For the steel slab centerline segregation application, the quantitative map is computed contemporaneously with the data collection, resulting in a near real time quantitative map of the atomic element Mn. This map can be displayed as a thermal continuous gradation map, where red represents the highest concentrations and blue represents the lowest concentrations for different locations. Further automatic scoring of a map, based on either an algorithmic schema and/or artificial intelligence image analysis, may follow. Results may then be automatically transferred to some distributed control system (DCS) for use in directing the production process. If additional maps were predefined at setup, then the system 10 can automatically save the first map and proceed to the next map on the initial sample 13 or on another sample 13 that is above, below, or to the side of the initial sample 13.

To return the system 10 to storage after use, the user will park the stages (e.g., X-stage 24, Y-stage 21, Z-stage 27, and Θ-stage 29), which may include rotating the spectrometer 17 to the vertical storage position, before powering down the system 10. Once the power source 203 and shop air have been disconnected, the movement features 31a-b are employed to move the system 10 to storage or to another sample 13.

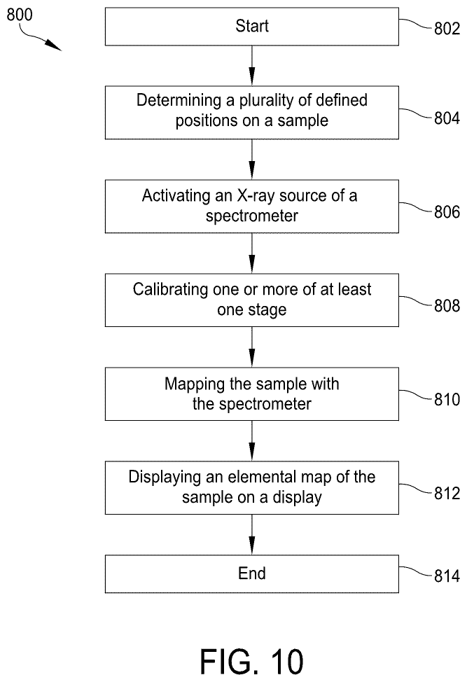

FIG. 10 illustrates a block diagram of an exemplary method, or operations, 800 of XRF analysis in accordance with some embodiments. The method 800 begins at block 802. The method 800 may include block 804 comprising determining a plurality of defined positions (e.g., corners 702, 704, 706, and 708) on a sample 13. The method 800 may include block 806 comprising activating an X-ray source 245 of a spectrometer 17. The method 800 may include block 808 comprising calibrating one or more of at least one stage (e.g., X-stage 24, Y-stage 21, Z-stage 27, and/or Θ-stage 29). The method 800 may include block 810 mapping the sample 13. The method 800 may include block 812 comprising displaying an elemental map of the sample 13 on a display, such as GUI 242. The method 800 may end at block 814.

In some embodiments, the method 800 may include moving a position of the spectrometer 17 such that the spectrometer 17 is adjacent to the sample 13. In some embodiments, the method 800 may include adjusting the spectrometer 17 by moving one or more of the at least one stage (e.g., X-stage 24, Y-stage 21, Z-stage 27, and/or Θ-stage 29). In some embodiments, the method 800 may include in response to one or more safety sensors 276 detecting an encroachment, securing the X-ray source 245. In some embodiments, the method 800 may include in response to activating the X-ray source 245, projecting an exclusion zone at a distance from the spectrometer 17.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

In this application, including the definitions below, the term “module” or the term “controller” may be replaced with the term “circuit.” The term “module” may refer to, be part of, or include processor hardware (shared, dedicated, or group) that executes code and memory hardware (shared, dedicated, or group) that stores code executed by the processor hardware.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are the BLUETOOTH wireless networking standard from the Bluetooth Special Interest Group and IEEE Standard 802.15.4.

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

It may be emphasized that the above-described embodiments, particularly any “preferred” embodiments, are merely possible examples of implementations, set forth for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

While this specification contains many specifics, these should not be construed as limitations on the scope of any disclosures, but rather as descriptions of features that may be specific to a particular embodiment. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. An X-ray fluorescence (XRF) analysis system comprising:
a stand having at least one stage and a movement feature, the movement feature being configured to facilitate a movement of the stand;
a spectrometer coupled to one of the at least one stage, the spectrometer being configured to move in one or more axes to analyze a sample; and
a computing device communicatively coupled to the stand and the spectrometer, the computing device having a processor with instructions to:
determine a plurality of defined positions of the sample;
activate an X-ray source of the spectrometer;
calibrate one or more of the at least one stage;
map the sample with the spectrometer; and
display an elemental map of the sample on a display.

2. The system of claim 1, wherein the at least one stage comprises at least one X-stage, a Y-stage, and a Z-stage.

3. The system of claim 2, wherein the spectrometer is coupled to the Z-stage.

4. The system of claim 3, wherein the Z-stage is configured to rotate around a plane defined by the Z-stage.

5. The system of claim 2, wherein the at least one X-stage comprises a first X-stage and a second X-stage.

6. The system of claim 1, wherein the spectrometer has one or more position sensors used to determine the plurality of defined positions on the sample.

7. The system of claim 1, further comprising a safety system communicatively coupled to the computing device.

8. The system of claim 7, wherein the safety system comprises one or more safety sensors configured to secure the X-ray source when the one or more safety sensors detect an encroachment.

9. The system of claim 7, wherein the safety system comprises one or more safety markers configured to project an exclusion zone at a distance from the spectrometer.

10. The system of claim 1, wherein the movement feature is a caster assembly.

11. A method of X-ray fluorescence analysis comprising:
determining a plurality of defined positions on a sample;
activating an X-ray source of a spectrometer;
calibrating one or more of at least one stage;
mapping the sample with the spectrometer; and
displaying an elemental map of the sample on a display.

12. The method of claim 11, further comprising moving a position of the spectrometer such that the spectrometer is adjacent to the sample.

13. The method of claim 11, further comprising adjusting the spectrometer by moving one or more of the at least one stage.

14. The method of claim 11, further comprising in response to one or more safety sensors detecting an encroachment, securing the X-ray source.

15. The method of claim 11, in response to activating the X-ray source, projecting an exclusion zone at a distance from the spectrometer.

16. A non-transitory computer readable medium having instructions stored thereon, wherein the instructions, when executed by at least one processor, cause a computing device to perform operations comprising:
determining a plurality of defined positions on a sample;
activating an X-ray source of a spectrometer;
calibrating one or more of at least one stage;
mapping the sample with the spectrometer; and
displaying an elemental map of the sample on a display.

17. The non-transitory computer readable medium of claim 16, further comprising moving a position of the spectrometer such that the spectrometer is adjacent to the sample.

18. The non-transitory computer readable medium of claim 16, further comprising adjusting the spectrometer by moving one or more of the at least one stage.

19. The non-transitory computer readable medium of claim 16, further comprising in response to one or more safety sensors detecting an encroachment, securing the X-ray source.

20. The non-transitory computer readable medium of claim 16, further comprising in response to activating the X-ray source, projecting an exclusion zone at a distance from the spectrometer.
